(19) United States
(12) Patent Application Publication
(10) Pub. No.: US 2004/0085509 A1
(43) Pub. Date: May 6, 2004

(54) Safety glasses with attached ear plug holders and/or attachable ear plug holders

(76) Inventor: Delane J. Lovelace, Sherman, TX (US)

Correspondence Address: DELANE LOVELACE, 1925 PEBBLEBROOK LANE, SHERMAN, TX, 75092, US

(21) Appl. No.: 10/427,065

(22) Filed: May 2, 2003

Related U.S. Application Data
(60) Provisional application No. 60/423,554, filed on Nov. 4, 2002.

(51) Int. Cl. G02C 5/14

(52) U.S. Cl. 351/123

(57) ABSTRACT

This invention consists of eye, safety, and/or prescription glasses with attached and/or attachable ear plug holders which may be attached or manufactured to glasses temple pieces by multiple means of molding, clips, clamps, screws, nuts, bolts, glueing, snaps, prongs, bands, such as plastic, metal, or rubber bands etc.

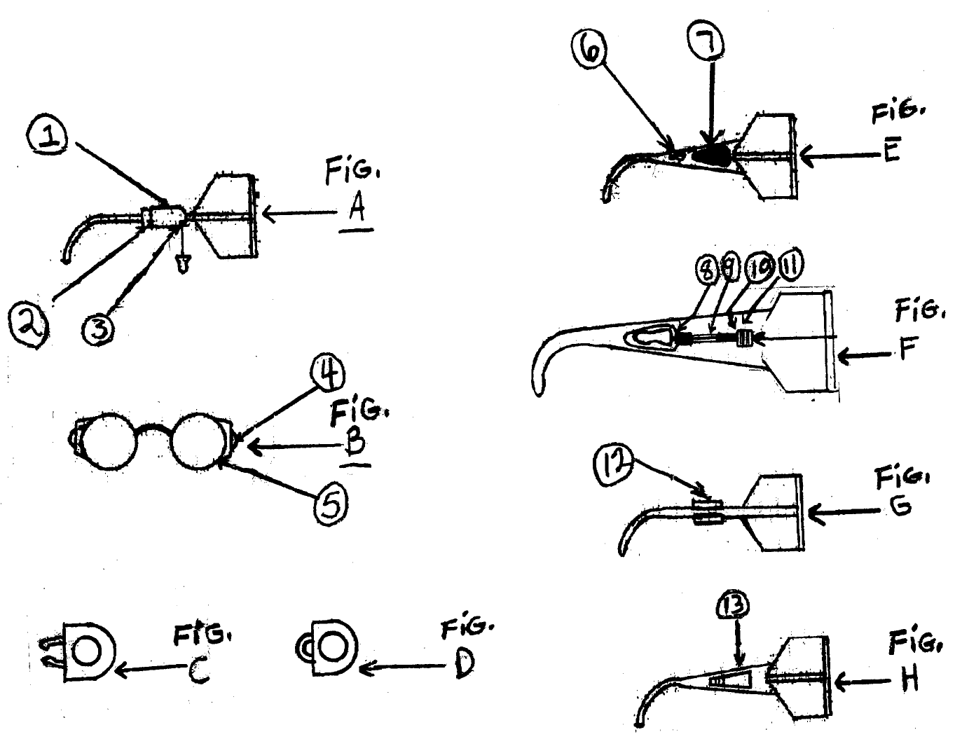

Claiming the benefit of the filing date of provisional application No. 60/423554, Filled on Nov. 4, 2002

### DESCRIPTION OF INVENTION

A. Sid view of glasses. #1. Ear plug holders which may be applied to glass s in different ways and are as proceeded. By manufacturing by means of molding, glueing, screws, nuts, bolts, clips, clamps, bands, rubber bands, etc. #2. is the side view of ear plug inserted into ear plug holder. #3. is a hole, clip, clamp, hook, prong which the cut or broken end of the ear plug cord or string can be affixed to. B. front view of glasses with ear plug holders. #4. is the front view of ear plug holder. #5. is the front view of the glasses lenses. C. is an attachable ear plug holder which may be clipped or clamped to glasses temple pieces. D. is an attachable ear plug holder which may be attached to glasses temple pieces by means of bands or rubber bands. E. is side view of glasses with a cavity in the temple pieces to hold ear plugs. #6. is a clamp, clip, hook, hole, prong, etc. so ear plug cord may be affixed to. #7. is the cavity to hold and store ear plug inside. F. is the side view of glasses with a cavity to hold and store ear plug and a slide bar with a finger tab so one may slide thus pulling ear plug into cavity for storage. This whole unit can be separate and independent and may be attached to eye, safety, or prescription glasses by means of clipping, clamping, glueing, screws, nuts, bolts, snaps, prongs, bands, rubber bands etc. #8. is the ear plug cavity. #9. is the track, channel, or slot holding the slide bar and tab. #10. is the slide bar which ear plug cord may be fastened to by means of a clamp, clip, hole, hook, prong, etc. #11. is the slide tab so one can slide bar with ones finger. G. is the side view of glasses with clip to hold ear plug. #12. is the clip. H. is the side view of glasses with clamp to hold ear plugs. #13. is a view of the clamp. Ear plugs with or without strings may b appli d to all glass s.

FIGURE: A and B

1. A device for holding and/or storing ear plugs to safety glasses with or without cords to each temple piece of eye glasses through a means of multiple applications for both attaching holders and ear plugs to eye glasses and/or temple pieces or frames.

2. the device according to claim 1. wherein are cylindrical ear plug holders which are two cylindrical shaped pieces one attached or manufactured to each temple piece of eye or safety glasses by means of molding, gluing, clamping, clipping, bands, such as rubber bands etc.

3. The device according claim 1. wherein are cordless ear plugs which may be stored in cylindrical shaped ear plug holders thusly;

4. A devise according to claim 1. wherein are corded ear plugs to which ear plug cord is broken or cut to length in order to reach from holders or temple pieces to ear canal for insertion of ear plug into ones ear canal and may be attached or tied to safety glasses or eye glasses by means of a clip, clamp, hook, prong, or inserting end of broken or cut end of ear plug cord in through a hole in temple pieces and/or ear plug holder and tying a knot as to keep one from loosing ear plugs should they fall from ear canals.

FIGURE: C and D

1. A device for h lding and/or storing ar plugs with or without cords to each temple pieces of eye glasses or safety glasses through a means of multiple applications for attaching ear plug holders to eye glasses and/or safety glasses temple pieces or frames;

2. The device according to claim 1. wherein are attachable ear plug holders which are cylindrical shaped pieces separate and independent from prescription or safety glasses and eye glasses and may be attached to glasses by means of clamping, clipping, glueing, bolting, screwing, snaps, prongs, and bands, such as rubber bands, etc.

3. The device according to claim 1. wherein are corded ear plugs which may be stored in attachable ear plug holders thusly;

4. A device according to claim 1. wherein are corded ear plugs to which ear plug cord is broken or cut to length in order to reach from holders or temple pieces to ear canal for insertion of ear plug into ones ear canal and may be attached or tied to safety glasses, prescription glasses, or eye glasses by means of clips, clamps, screws, bolts, glueing, snaps, prongs, bands, such as rubber bands, and by means of breaking or cutting ear plug cord and inserting end of cord into hole predrilled hole in cylinder wall and inserting end of ear plug cord through hole and tying a knot.

FIGURE: E

1. A d vice for holding and/ r storing ear plugs with or without cords to each temple piece of eye glasses, safety glasses, or prescription glasses through a means of cavity type ear plug holders and multiple means by which to attach ear plugs to cavity type holders and/or eye, safety, or prescription glasses temple pieces or holders;

2. The device according to claim 1. wherein are ear plug holders comprising of cavities molded to or attached to eye, safety, or prescription glasses temple pieces for holding storing ear plugs when ear plugs are not in use;

3. The device according to claim 1. wherein are cavities molded or attached to eye, safety, or prescription glasses temple pieces which are attached to glasses by means of molding, clips, clamps, screws, bolts, glueing, snaps, prongs, bands, such as rubber bands etc.

4. The device according to claim 1. are corded ear plugs which may be attached to cavity holders or temple pieces by means of clips, clamps, snaps, hooks, prongs or inserting the broken or cut end of the ear plug cord into predrilled hole in cavity holder or glasses temple pieces for storage of ear plugs when not in use;

5. The device according to claim 1. wherein are cordless ear plugs which which may be stored in ear plug holder cavities on glasses temple pieces or in an independent separate attachable unit.

FIGURE: F

1. A device for h lding and/or storing ear plugs with or without cords to ach temple piece of eye, safety, or prescription glasses by means of cavity type ear plug holders with multiple means by which to attach ear plugs to cavity holders and/or eye, safety, and prescription glasses or temple pieces;

2. The device according to claim 1. wherein ear plug holders comprising of cavities molded to or attached to eye, safety, or prescription glasses temple pieces for holding and storing ear plugs when not in use;

3. The device according to claim 1. wherein are cavities with slide bars and finger tabs molded or attached to eye, safety, or prescription glasses temple pieces and comprising of a finger tab attached to a slide bar which the end of a cut or broken corded ear plug is attached to by means of clips, clamp, hooks, prongs, snaps, or by inserting cut or broken end of ear plug cord in end of slide bar and tying a knot so when ear plugs are not in use they may be stored in cavity holders by sliding tab with ones fingers thus sliding slide bar therefor drawing ear plug into cavity in glasses cavity holder;

4. The device according to claim 1. wherein are cordless ear plugs which may be stored in cavities in eye, safety, or prescription glasses temple pieces or in an independent separate attachable unit which is attached to temple pieces by means of clamps, clips, glueing, srews, bolts, nuts, snaps, prongs, bands, such as rubber bands, etc.;

FIGURE: G and H

1. A device for holding and/or storing ear plugs with or without cords to to each eye, safety, prescription glasses temple pieces with two types of ear plug holders which consist of clips and/or clamps which are manufactured or attached to eye, safety, or prescription glasses by means of molding, glueing, clips, clamps, screws, nuts, bolts, snaps, prongs, bands, such as rubber bands etc.;

2. The device according to claim 1. wherein is a clip for holding and storing ear plugs when not in use which is manufactured or attached to temple pieces of eye, safety, or prescription glasses temple pieces by means of molding, glueing, clips clamps, screws, nuts, bolts, snaps, prongs, bands, such as rubber bands etc.;

3. The device according to claim 1. wherein is a clamp for holding and storing ear plugs when not in use which is manufactured or attached to temple pieces of eye, safety, or prescription glasses by means of molding, glueing, clips, clamps, screws, nuts, bolts, snaps, prongs, bands, such as rubber bands ect.;

4. The device according to claim 1,2, and 3. wherein ear plugs with and without cords maybe applied to both clip and clamp type ear plug holders by means of clips, clamps, hooks, prongs, or by inserting end of cut or broken ear plug cord into predrilled or manufactured hole of clamps, clips, or temple pieces of glasses

What I claim for my invention is:

1. A device for holding and/or storing earplugs with or without cords to each temple piece of eye glasses or safety glasses through two means of cavity type ear plug holders and multiple mean by which to attach ear plugs to cavity type holders and/or eye or safety glasses temple pieces:

2. The device according to claim 1. wherein ear plug holders comprising of cavities molded to or attached to eye glasses or safety glasses temple pieces for holding and storing ear plugs when ear plugs are not in use;

3. The device according to claim 1. wherein are cavities molded to or attached to eye glasses or safety glasses temples comprising of a finger tab attached to a slide bar which the end of the broken or cut corded ear plug cord is attached to by means of dip, damp, hook, prong, or running end of ear plug cord through a hole in end of slide bar and tying a knot so when ear plugs are not in use they may be stored in cavity holders by sliding tab with ones finger thus sliding slide bar therefor drawing ear plug into cavity in safety glasses temple pieces for storage of ear plugs when not in use:

4. The device according to claim 1. wherein are cordless ear plugs which may be stored in cavities in safety glasses or eye glasses temple pieces or in an independent separate attachable unit which is attached to the temple pieces.
